(19) United States
(12) Patent Application Publication
(10) Pub. No.: US 2025/0313742 A1
(43) Pub. Date: Oct. 9, 2025

(54) REMOVAL OF HAZARDOUS CHEMICALS DURING DRILLING IN HYDROCARBON FORMATIONS

(71) Applicant: CONOCOPHILLIPS COMPANY, Houston, TX (US)

(72) Inventor: Gunvald NESHEIM, Tananger (NO)

(21) Appl. No.: 19/169,781

(22) Filed: Apr. 3, 2025

Related U.S. Application Data
(60) Provisional application No. 63/574,070, filed on Apr. 3, 2024.

(51) Int. Cl. C09K 8/34; B01J 20/28; E21B 21/00

(52) U.S. Cl. CPC C09K 8/34; B01J 20/28004; B01J 20/28016; B01J 20/28061; B01J 20/28064; B01J 20/28066; B01J 20/28083; E21B 21/00

(57) ABSTRACT

The invention relates to a drilling fluid having adsorbent particles added to it and also to a method of drilling a well into a subterranean hydrocarbon reservoir. The adsorbent particles adsorb benzene and toluene that has been taken up in the drilling fluid from the hydrocarbon reservoir. This mitigates the problem of benzene vapor being released at the surface, especially at the shaker. The adsorbent particles can be of a size that allows them to be separated from rock cuttings in the shaker and recirculated into the drilling fluid. When the drilling job is complete, the adsorbent particles may be disposed of safely.

### CROSS-REFERENCE TO RELATED APPLICATIONS

This application is a non-provisional application which claims benefit under 35 USC § 119 (e) to U.S. Provisional Application Ser. No. 63/574,070 filed Apr. 3, 2024 entitled “REMOVAL OF HAZARDOUS CHEMICALS DURING DRILLING IN HYDROCARBON FORMATIONS,” which is incorporated herein in its entirety.

### FEDERALLY SPONSORED RESEARCH AND DEVELOPMENT

None.

### FIELD OF THE INVENTION

This invention relates to the removal of hazardous chemicals, e.g. benzene, from drilling fluid when drilling for hydrocarbons (oil and gas).

### BACKGROUND OF THE INVENTION

Fluids returned to the surface during drilling into subterranean hydrocarbon-bearing formations may be contaminated with undesirable and potentially hazardous organic chemicals. The presence of such chemicals needs to be reduced to acceptable levels.

In particular, volatile organics such as benzene and toluene may be present in drilling fluid circulated back to the surface. When drilling the hydrocarbon-bearing formations there is often some uptake of benzene into the drilling fluid. This is especially true in a non-aqueous drilling fluid system, although it can occur also in an aqueous system. Benzene in non-aqueous drilling fluid (which will normally be at an elevated temperature due to the high temperature of the formation) may be released as vapor at the surface. Benzene is a carcinogenic organic chemical compound.

Current approaches to this problem involve air filtration at the surface, by degassers and by the shale shakers where drilled solids are removed from drilling fluid. Workers may also wear P.P.E. to reduce the risk of inhaling benzene or other hazardous vapors. These approaches may not be fully satisfactory, however, and official requirements for the removal of benzene are set to become more stringent in the near future in some territories. Part of the problem is that the released benzene is hazardous and may have high local concentrations in the areas affected.

After a drilling operation, a large percentage of the drilling fluid (mud)—perhaps 80%—is normally cleaned or re-processed and then re-used in a later drilling operation. The drilling fluid is normally transported to shore for this purpose if the drilling operation is offshore. The drilling fluid may still contain hazardous organics such as benzene, which may become airborne during the transport, cleaning or re-processing procedures or in some other way present a hazard in the transport or re-processing of the drilling fluid.

US20220025735A1 describes the injection of nanoparticles into a well during gas lift to absorb asphaltenes to reduce the presence of asphaltenes in produced fluids.

The adsorption or absorption of benzene and other organics by different materials is described, for example, in the following references.

Yu Lu, Yilian Li, Danqing Liu, Yu Ning, Sen Yang, Zhe Yang, Adsorption of benzene vapor on natural silicate clay minerals under different moisture contents and binary mineral mixtures, Colloids and Surfaces A: Physicochemical and Engineering Aspects, volume 585, 20 Jan. 2020, 124072.

Mohammad Mehdi Sabzehmeidani, Sahar Mahnaee, Mehrorang Ghaedi, Hadi Heidari and Vellaisamy A. L. Roy, Carbon based materials: a review of adsorbents for inorganic and organic compounds, Chemical Engineering Department, Yasouj University, Yasouj, Iran, James Watt School of Engineering, University of Glasgow, Glasgow, U.K., 5th January 2021.

Sobhy M Yakout, Removal of the hazardous, volatile, and organic compound benzene from aqueous solution using phosphoric acid activated carbon from rice husk, Chemistry Central Journal volume 8, Article number: 52 (2014).

Zahra Shamsollahi, Ali Partovinia, Recent advances on pollutants removal by rice husk as a bio-based adsorbent: A critical review, Journal of Environmental Management, Volume 246, 15 Sep. 2019, Pages 314-323.

Sobhy M Yakout, Removal of the hazardous, volatile, and organic compound benzene from aqueous solution using phosphoric acid activated carbon from rice husk, Chem Cent J. 2014; 8:52, published online 2014 Sep. 3, doi: 10.1186/s13065-014-0052-5.

U.S. Pat. Nos. 5,207,282, 5,180,020 describe the strengthening of hydrocarbon-bearing formations by incorporation of particulates into drilling fluid.

The contents of all the above references are incorporated herein by reference.

### BRIEF SUMMARY OF THE DISCLOSURE

The invention more particularly includes a process for drilling a hydrocarbon production or injection well into a hydrocarbon bearing formation, wherein the process comprises circulating drilling fluid into the well and back to the surface, wherein the drilling fluid comprises particles of a material that adsorbs or absorbs at least one hazardous volatile organic substance present in the formation.

The problem is observed in non-aqueous drilling fluid but may also be an issue in aqueous drilling fluid. The most commonly observed hazardous substance is benzene or toluene.

Depending on a number of different factors, the particles may have dimension between 100 μm and 5 mm, optionally between 200 μm and 1000 μm, such as between 220 μm and 955 μm, such as between 250 μm and 800 μm or 250 and 600 μm. Alternatively, depending on the way in which it is planned to separate the particles from the drilling fluid, they may have dimension between 100 μm and 150 μm.

The weight of the material in the drilling fluid per unit volume of fluid may be between 0.011 kg/m3 to 57 kg/m3, optionally between 0.5 and 10 kg/m3, such as between 1 and 5 kg/m3, or between 2 and 3 kg/m3.

The material of the particles may be selected from: activated carbon, activated carbon derived from natural waste cellulose products, rice husk derived activated carbon, coconut derived activated carbon, carbon nanotubes, fullerenes and silica clays. The material may have pores that are capable of receiving a benzene or toluene molecule. These may be micropores or mesopores according to the IUPAC definition of those terms (mesopore: 2-50 nm diameter; micropore: less than 2 nm diameter). The material may have a specific surface area of between 500 m2/g and 5,000 m2/g, such as between 1,000 m2/g and 3,000 m2/g.

The particulate material may provide a wellbore strengthening function in addition to adsorbing or absorbing hazardous chemicals; it may accumulate in fractures in the formation and inhibit further fracturing of the formation. A dedicated wellbore strengthening particulate material would normally present in the drilling fluid—the adsorbent or absorbent particles may provide part of the required amount of wellbore strengthening particles.

The invention also includes drilling fluid for passing into a well being drilled into a hydrocarbon bearing subterranean formation, wherein the drilling fluid comprises particles of a material that adsorbs or absorbs at least one hazardous volatile organic substance present in the formation. The fluid may be aqueous or non-aqueous.

The drilling fluid may comprise particles having dimension between 100 μm and 5 mm, optionally between 200 μm and 1000 μm, such as between 220 μm and 955 μm, such as between 250 μm and 800 μm or 250 and 600 μm. Alternatively, the drilling fluid may have particles with dimension between 100 μm and 150 μm.

The material of the drilling fluid may be selected from: activated carbon, activated carbon derived from natural waste cellulose products, rice husk derived activated carbon, coconut derived activated carbon, e.g. activated carbon derived from coconut husk (including waste coconut husk), carbon nanotubes, fullerenes and silica clays. The weight of the material in the drilling fluid per unit volume of fluid is between 0.011 kg/m3 to 57 kg/m3, optionally between 0.5 and 10 kg/m3, such as between 1 and 5 kg/m3, or between 2 and 3 kg/m3. The material may have pores that are capable of receiving a benzene or toluene molecule, optionally wherein the said material has micropores or mesopores. The material may have a specific surface area of between 500 m2/g and 5,000 m2/g, such as between 1,000 m2/g and 3,000 m2/g.

Examples and various features and advantageous details thereof are explained more fully with reference to the exemplary, and therefore non-limiting, examples detailed in the following description. Descriptions of known starting materials and processes can be omitted so as not to unnecessarily obscure the disclosure in detail. It should be understood, however, that the detailed description and the specific examples, while indicating the preferred examples, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, product, article, or apparatus that comprises a list of elements is not necessarily limited only those elements but can include other elements not expressly listed or inherent to such process, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term substantially, as used herein, is defined to be essentially conforming to the particular dimension, shape or other word that substantially modifies, such that the component need not be exact. For example, substantially cylindrical means that the object resembles a cylinder, but can have one or more deviations from a true cylinder.

Additionally, any examples or illustrations given herein are not to be regarded in any way as restrictions on, limits to, or express definitions of, any term or terms with which they are utilized. Instead these examples or illustrations are to be regarded as being described with respect to one particular example and as illustrative only. Those of ordinary skill in the art will appreciate that any term or terms with which these examples or illustrations are utilized encompass other examples as well as implementations and adaptations thereof which can or cannot be given therewith or elsewhere in the specification and all such examples are intended to be included within the scope of that term or terms. Language designating such non-limiting examples and illustrations includes, but is not limited to: “for example,” “for instance,” “e.g.,” “In some examples,” and the like.

Although the terms first, second, etc. can be used herein to describe various elements, components, regions, layers and/or sections, these elements, components, regions, layers and/or sections should not be limited by these terms. These terms are only used to distinguish one element, component, region, layer or section from another. Thus, a first element, component, region, layer or section discussed below could be termed a second element, component, region, layer or section without departing from the teachings of the present inventive concept.

Where definitions of particle size refer to an API screen number, they reference the API RP 13C standard (ISO 13501). The term “d100” separation or cut point means that essentially all particles below a given micron size will pass through a mesh or screen with a certain API number.

The terms micro and meso pores refer to IUPAC definitions: micropores are pores with diameter less than 2 nm; mesopores are pores with diameter between 2 nm and 50 nm.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

When drilling into hydrocarbon-bearing formations, it is necessary to circulate drilling fluid to lubricate the drilling process and to carry drilled-out rock to the surface. There may be some uptake of benzene or toluene or other hazardous volatile organics into the drilling fluid system. Drilling fluid may be aqueous or non-aqueous (oil based). This problem arises particularly when non-aqueous fluid is used but can also occur where aqueous fluid is used.

Benzene gas or other volatile organics with relatively low boiling points that are dissolved in non-aqueous drilling fluid (drilling mud) may be released at the surface. Since formations many thousands of feet under the surface are at elevated temperatures, the drilling fluid is frequently at an elevated temperature when it reaches the shaker. Attempts are made to keep the temperature down, e.g. to about 60° C., but this still results in hazardous vapors being released. For example, benzene has a boiling point of about 80° C. and at 60° C. there will be a significant amount of vapor released. Whilst in the well, the drilling fluid is under pressure, but as pressure is released at the surface, organics such as benzene may be released. These vapors can be hazardous. Benzene, in particular, is a carcinogenic organic chemical compound.

Benzene or other volatile organics tend to be released at the shaker. The shaker is a piece of equipment at the surface that separates larger solid particles, e.g. rock cuttings, from the drilling mud. Non Aqueous Drilling Fluid consists of an oil phase, a water phase and a solids phase, while an aqueous drilling fluid consists of a water and a solids phase only.

The shaker may be enclosed and have ventilation and filters to extract volatile organics such as benzene from the air to mitigate the hazard. Workers may also wear protective clothing or masks, etc. (P.P.E.). However, such systems are not perfect and it would be desirable to reduce further the level of airborne volatile organics such as benzene.

The inventor has conceived a method for removing volatile organics such as benzene by adsorption or absorption by particles in the drilling fluid. When adsorbed or absorbed by particles, volatile organics may no longer present the same level of hazard at the surface since the adsorbed/absorbed organics are not able (or are much less able) to become air borne.

The size of the adsorbent/absorbent particles may be such that they can be removed from the drilling fluid at the shaker. The particles, including the adsorbed/absorbed organics such as benzene, may then be disposed of safely, either by reinjection into a well for disposal or destruction at a waste handling site. The particles may form part of the re-circulated drilling fluid and be passed back into the well that is currently being drilled. Once drilling has finished, the particles may be filtered out and disposed of.

The size of particle that would be most beneficial is currently being researched by the inventor. One factor that may be taken into account may be the availability of inexpensive adsorbent/absorbent particles of certain sizes and the possibility of granulating smaller particles. Another factor is the way in which the particles are to be separated in the shaker either for re-circulation or disposal or filtered out in some later process for disposal. Another factor in selecting size may be the effectiveness of the particles at absorbing/adsorbing hazardous chemicals, e.g. benzene, and potentially also the effectiveness of the particles at a secondary function, such as strengthening the wellbore.

It is believed that the particle size should probably be above 100 μm, preferably above 150 μm, to allow separation from fine particles (1-100 μm) that make up the drilling fluid itself. However, the optimum size to facilitate separation of particles may to some extent depend on the design of shaker and the mesh sizes of the shaker screens, as well as where (what deck/mesh) in the shaker the adsorbent/absorbent particles are to be separated.

A typical design of shaker has three meshes-known as a triple deck shaker with particle recovery. In this design, drilling fluid passes through an API 18 scalping screen that has d100 separation of 955 μm. That will allow particles below 955 μm to pass through while every particle above 955 μm will be discarded to waste. This screen is intended primarily to separate rock cuttings from the drilling fluid.

Particles that are retained on the middle recovery deck screens are similar to API 60-API 70 in d100 cut point.

All particles between 220 μm to 955 μm are recovered on the middle screen. The bottom deck is dressed with as fine a screen as possible to clean the mud of fine solids.

The recovered particles at the second screen are added back into drilling fluid stream after the final screen. In this way, a certain particle size is recovered while the coarsest and finest are discarded to waste.

If this design of shaker is used, therefore, it is preferred that the adsorbent/absorbent particles are between 220 μm to 955 μm.

However, these sizes will depend on the exact design of shaker, for example the first screen might separate particles of 1,000 μm or even 1,500 μm, whilst the second screen might filter out particles of 150 μm, 200 μm, 300 μm or 400 μm. Furthermore, if it were not desired to recycle the adsorbent/absorbent particles within a given drilling operation, then the particles could theoretically be large enough to be screened out with the rock cuttings. In that case particles of perhaps up to 5 mm might be used.

Alternatively, the adsorbent/absorbent particles could be designed to be separated out at the lower deck/mesh of the shaker, in which case a size range of 100 μm to 150 μm is suitable.

The range of possible sizes is therefore from 100 μm to 5,000 μm. An optional size range would be 150 μm to 1,500 μm and a further optional range would be 200 μm to 1,000 μm or 200 μm to 800 μm.

As discussed in more detail below, the particles may have a second function of strengthening the wellbore. U.S. Pat. Nos. 5,207,282 and 5,180,020, both incorporated herein by reference, indicate that the ideal size range of particles for this purpose is 250 to 800 microns or 250 to 600 microns, optionally where at least 75% by weight of the particles are in a size range from −35/+50 mesh. These optional ranges apply to the present invention since adsorbent/absorbent particles in this size range may both absorb/adsorb hazardous chemicals whilst potentially also having a wellbore strengthening effect.

The amount of absorbent/absorbent particle to add that would be most beneficial is currently being researched by the inventor. If activated carbon is used as an adsorbent material, some forms of activated carbon can theoretically adsorb 130% by volume of benzene. Another figure that is quoted for some activated carbons (e.g. derived from rice husk) is 365 mg of benzene per gram of activated carbon. Based on some initial very approximate measurements of the amount of benzene present, the concentration of adsorbent particles could be as little as 11-12 ppm or 0.011-0.012 kg/m3. This would mean as little as 4 or 5 kg of adsorbent being added to a standard 400m3 drilling mud system.

In practice, it is likely that considerably more adsorbent/absorbent material would be added, since (i) suitable materials can be sourced at low expense and there is little cost impact if more is added to ensure maximum possible take up of benzene or other hazardous chemicals, (ii) the adsorbent/absorbent particles may not take up their full theoretical capacity of benzene or other hazardous chemicals, (iii) the adsorbent/absorbent particles may take up other chemicals in the drilling fluid that are not of concern, thereby preventing uptake of benzene or other hazardous substances that are of concern, and (iv) it may be desirable from another viewpoint to have more of this inexpensive particulate material added, e.g. wellbore strengthening.

U.S. Pat. Nos. 5,207,282 and 5,180,020, both incorporated herein by reference, indicate that 30 to 80 pounds of wellbore strengthening particles are added per barrel of drilling fluid/mud. This equates to between about 85 kg/m3 and 228 kg/m3 weight of particles per unit volume of drilling fluid. Since these patents were filed, the amount of wellbore strengthening material has been reduced due to finding more effective materials and is now more like a maximum of 20 pounds per barrel, equating to 57 kg/m3. Therefore, if wellbore strengthening particles were to be replaced entirely with absorbent/adsorbent particles, then as much as 228 kg/m3 weight of particles per unit volume of drilling fluid could be added, but more likely up to 57 kg/m3. However, it is much more likely that the adsorbent/absorbent particles are either added to the drilling fluid without altering the amount of wellbore strengthening particles to be added, or alternatively that adsorbent particles are added to make up a proportion of the total amount of particles that have a wellbore strengthening effect. Based on approximate measurements to date, 57 kg/m3 would be very considerably more adsorbent/absorbent material than would be required to take up essentially all the benzene or other volatile organics in the drilling fluid. Therefore, a compromise could be to add between 0.5 and 10 kg/m3, e.g. between 1 and 5 kg/m3.

Although more experimental work is planned, at present the inventor believes the addition of about 1000 kg per section may be appropriate, taking into account all the currently unknown factors listed above. This corresponds to a value of between 2 and 3 kg/m3. This is still a low figure compared to the amount of wellbore strengthening particulate that is normally added, but high enough to contribute to the wellbore strengthening function. This amount would probably equate to adding one 25 kg sack of adsorbent/absorbent particulate per hour during drilling.

As mentioned above, the adsorbent/absorbent particles may have a secondary benefit of strengthening the formation. This is also called wellbore strengthening. The purpose is to enable a higher pressure in the wellbore before losses are encountered, i.e. drilling fluid being lost into fracturing in the formation. Appropriate size particles in the drilling fluid may enter natural fractures in the formation and accumulate at the fracture tip. By filling up the fracture at the tip, a stress multiplier is removed, thereby making it harder to fracture the rock. This methodology is known, e.g. from U.S. Pat. No. 5,207,282, 5,180,020 in the name of the applicant, and the contents of these patents are incorporated by reference.

Activated carbon derived from rice husks is already described as powerful benzene adsorber in waste water (see article referenced above by Sobhy M Yakout). This is likely to be an inexpensive product that could easily be added in bulk to the drilling fluid at low cost, and may also provide a wellbore strengthening function. This would in effect be using a waste product (rice husk) to clean a fluid of harmful organic compounds and potentially also help the drilling operation by strengthening the wellbore.

Rice husk activated carbon retains a graphitic structure after activation. Graphite is already used in drilling fluid so this may indicate that rice husk derived activated carbon could be mixed into drilling fluid without issues. Benzene is oil-soluble so in an oil based drilling fluid it may follow the oil phase into the micro and mezo pores of the activated carbon where it may lodge. The inventor understands that rice husk derived activated carbon (activated by phosporic acid) has a natural affinity for aromatic compounds like benzene.

Activated carbon derived from waste coconut husk is a similar material to rice husk derived activated carbon, and the inventor believes it to possess similar advantages, such as retaining graphtic structure after activation, the structure having micro and meso pores and having an affinity for aromatic compounds like benzene. Coconut husk derived activated carbon is, like rice husk activated carbon, a relatively inexpensive material.

The inventor is at this point conducting further experimental work to establish which materials are most effective at adsorbing or absorbing volatile organics, especially benzene, whilst potentially also having sufficient strength to achieve wellbore strengthening. Other possibilities for suitable materials may include carbon nanotubes or silicate clay minerals or any other of the materials referred to in the articles cited above, or indeed any solid material that has the ability to adsorb/absorb a material amount of benzene or other volatile hazardous organics.

For example, materials with meso or micro pores may be suitable for adsorbing benzene or toluene or other similar aromatics, and/or materials with a high specific surface area of more than 500 m2/g.

Current ongoing testing is using coconut husk derived activated carbon particles. Two size ranges are currently being tested: 8×16 mesh (1.18 mm to 2.36 mm) and 20×50 mesh (0.30 mm to 0.85 mm). Further testing is planned for other size ranges.

The activated carbon in the current ongoing testing has a specific surface area of 1100 m2/g. A larger specific surface area would be preferred (in the range 1100 to 3000 m2/g) but the lower end of this range was more easily available. It is planned to test carbon with a higher specific surface area in the future.

The testing is being conducted by adding the activated carbon to an oil based (non-aqueous) drilling fluid and is being carried out at elevated temperature to simulate downhole conditions. Initial testing is at 60 degrees C. but it is hoped to test at higher temperatures (e.g. 120 degrees C.) at a future date, and also to test at elevated pressures such as would be encountered downhole. Initial testing is on a ratio of 3.2 kg of activated carbon per m3 of drilling fluid.

It is believed that the activated carbon particles could adsorb or absorb benzene, toluene or other volatile organics at downhole pressures and temperatures that can range from 100 to 20000 psi and 50 to 200 degrees C.

In closing, it should be noted that the discussion of any reference is not an admission that it is prior art to the present invention, especially any reference that may have a publication date after the priority date of this application. At the same time, each and every claim below is hereby incorporated into this detailed description or specification as a additional embodiments of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

### REFERENCES

The discussion of any reference is not an admission that it is prior art to the present invention, especially any reference that may have a publication date after the priority date of this application. All references cited herein and listed below are expressly incorporated by reference in their entirety for all intents and purposes.
1) Yu Lu, Yilian Li, Danqing Liu, Yu Ning, Sen Yang, Zhe Yang, Adsorption of benzene vapor on natural silicate clay minerals under different moisture contents and binary mineral mixtures, Colloids and Surfaces A: Physicochemical and Engineering Aspects, volume 585, 20 Jan. 2020, 124072.
2) Mohammad Mehdi Sabzehmeidani, Sahar Mahnaee, Mehrorang Ghaedi, Hadi Heidari and Vellaisamy A. L. Roy, Carbon based materials: a review of adsorbents for inorganic and organic compounds, Chemical Engineering Department, Yasouj University, Yasouj, Iran, James Watt School of Engineering, University of Glasgow, Glasgow, U.K., 5th January 2021.
3) Sobhy M Yakout, Removal of the hazardous, volatile, and organic compound benzene from aqueous solution using phosphoric acid activated carbon from rice husk, Chemistry Central Journal volume 8, Article number: 52 (2014).
4) Zahra Shamsollahi, Ali Partovinia, Recent advances on pollutants removal by rice husk as a bio-based adsorbent: A critical review, Journal of Environmental Management, Volume 246, 15 Sep. 2019, Pages 314-323.
5) Sobhy M Yakout, Removal of the hazardous, volatile, and organic compound benzene from aqueous solution using phosphoric acid activated carbon from rice husk, Chem Cent J. 2014; 8:52, published online 2014 Sep. 3, doi: 10.1186/s13065-014-0052-5.
6) U.S. Pat. No. 5,207,282, “Method for inhibiting the initiation and propagation of formation fractures while drilling and casing a well.”
7) U.S. Pat. No. 5,180,020, “Method for inhibiting the initiation and propagation of formation fractures while drilling.”
8) US20220025735A1, “Reducing asphaltenes in produced fluids from a wellbore.”

1. A process for drilling a hydrocarbon production or injection well into a hydrocarbon bearing formation, wherein the process comprises circulating drilling fluid into the well and back to the surface, wherein the drilling fluid comprises particles of a material that adsorbs or absorbs at least one hazardous volatile organic substance present in the formation.

2. The process according to claim 1, wherein the drilling fluid is non-aqueous.

3. The process according to claim 1, wherein the hazardous substance is benzene or toluene.

4. The process according to claim 1, wherein the particles have dimension between 100 μm and 5 mm, optionally between 200 μm and 3000 μm, such as between 220 μm and 955 μm, such as between 250 μm and 850 μm or 250 and 600μ m.

5. The process according to claim 1, wherein the particles have dimension between 100 μm and 150 μm.

6. The process according to claim 1, wherein the said material is selected from: activated carbon, activated carbon derived from natural waste cellulose products, coconut husk derived activated carbon, rice husk derived activated carbon, carbon nanotubes, fullerenes and silica clays.

7. The process according to claim 1, wherein the weight of the material in the drilling fluid per unit volume of fluid is between 0.011 kg/m3 to 57 kg/m3, optionally between 0.5 and 10 kg/m3, such as between 1 and 5 kg/m3, or between 2 and 4 kg/m3.

8. The process according to claim 1, wherein the particles have pores that are capable of receiving a benzene or toluene molecule, such as micropores or mesopores.

9. The process according to claim 1, wherein the particles are capable of adsorbing or absorbing benzene, toluene or other volatile organics in conditions down a hydrocarbon well, such as a temperature range of 50 to 200 degrees C. and/or a pressure of between 100 and 20,000 psi.

10. The process according to claim 1, wherein the particles have a specific surface area of between 500 m2/g and 5,000 m2/g, such as between 1,000 m2/g and 3,000 m2/g.

11. The process according to claim 1, wherein the particles accumulate in fractures in the formation and inhibits further fracturing of the formation.

12. The process according to claim 1, wherein a dedicated wellbore strengthening particulate material is present in the drilling fluid in addition to the said particles of adsorbent or absorbent material.

13. A drilling fluid for passing into a well being drilled into a hydrocarbon bearing subterranean formation, wherein the drilling fluid comprises particles of a material that adsorbs or absorbs at least one hazardous volatile organic substance present in the formation.

14. A drilling fluid according to claim 13 that is non-aqueous.

15. A drilling fluid according to claim 13, wherein the particles have dimension selected from: between 100 μm and 5 mm, between 200 μm and 3000 μm, between 220 μm and 955 μm, between 250 μm and 850 μm, and between 250 and 600 μm.

16. A drilling fluid according to claim 13, wherein the particles have dimension between 100 μm and 150 μm.

17. A drilling fluid according to claim 13, wherein the said material is selected from: activated carbon, activated carbon derived from natural waste cellulose products, coconut husk derived activated carbon, rice husk derived activated carbon, carbon nanotubes, fullerenes and silica clays.

18. A drilling fluid according to claim 13, wherein the weight of the said material in the drilling fluid per unit volume of fluid is selected from between: 0.011 kg/m³ to 57 kg/m³, between 0.5 and 10 kg/m³, between 1 and 5 kg/m³, and between 2 and 4 kg/m³.

19. A drilling fluid according to claim 13, wherein the particles have pores that are capable of receiving a benzene or toluene molecule, optionally wherein the particles have micropores or mesopores.

20. A drilling fluid according to claim 13, wherein the particles have a specific surface area selected from: between 500 m²/g and 5,000 m²/g and between 1,000 m²/g and 3,000 m²/g.
